(19) United States
(12) Patent Application Publication
(10) Pub. No.: US 2014/0040772 A1
(43) Pub. Date: Feb. 6, 2014

(54) HIGHLIGHTING GRAPHICAL USER INTERFACE COMPONENTS BASED ON USAGE BY OTHER USERS

(71) Applicant: Robert Murata, Mountain View, CA (US)

(72) Inventor: Robert Murata, Mountain View, CA (US)

(73) Assignee: Adobe Systems Incorporated, San Jose, CA (US)

(21) Appl. No.: 13/316,910

(22) Filed: Dec. 12, 2011

(51) Int. Cl. G06F 3/01

(52) U.S. Cl. 715/753

(57) ABSTRACT

In one example embodiment, a method to highlight graphical user interface (GUI) components is provided. In this method, a computing device on a network is queried to identify which of the GUI components to highlight based on tracking information associated with other users. A response to the query is then received from the computing device, the response of which identifies a GUI component, and this identified GUI component is highlighted.

### FIELD

The present disclosure relates generally to computer graphics. In one example embodiment, the disclosure relates to highlighting of graphical user interface components based on usage of the components by other users.

### BACKGROUND

A graphical user interface (GUI) allows users to interact with computing devices with images rather than text components. A GUI typically includes components, such as icons and menus, that can represent information and actions available to a user. A user can activate such actions through direct manipulation of the components.

Many conventional GUI layouts are available to guide a user to helpful or new features in an application. For example, previous methods have involved a software developer manually choosing which GUI components to highlight before it was given to the end user for use. In another example, some applications are designed to automatically highlight components that reference newly installed features of the applications.

### BRIEF DESCRIPTION OF DRAWINGS

The present disclosure is illustrated by way of example and not limitation in the figures of the accompanying drawings, in which like references indicate similar elements and in which:

FIGS. 1A and 1B depict graphical user interfaces (GUIs) having various GUI components, in accordance with example embodiments of the present invention;

FIGS. 2A and 2B are diagrams of example embodiments of various network systems, which can provide the highlighting functionalities described herein, such as the highlighting depicted in FIG. 1B;

FIG. 3 depicts a block diagram of a highlight tracking module in accordance with an example embodiment, that can be deployed in the network system depicted in FIG. 2;

FIG. 4 depicts a flow diagram of a general overview of a method, in accordance with an embodiment of the present invention, for tracking usage of GUI components by a user;

FIG. 5 depicts a flow diagram of a general overview of a method, in accordance with an example embodiment, for highlighting certain GUI components;

FIG. 6 depicts a block diagram of a tracking information storage module, in accordance with an example embodiment, that can be deployed in the network system depicted in FIG. 2;

FIG. 7 depicts an example of a data structure, in accordance with an example embodiment, that can be included in the data storage of FIG. 3;

FIG. 8 depicts a flow diagram of a general overview of a method, in accordance with an embodiment, for identifying which GUI components to highlight based on the received tracking information; and

FIG. 9 depicts a block diagram of a machine in the example form of a computing device, such as the computing devices depicted in FIG. 2, within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

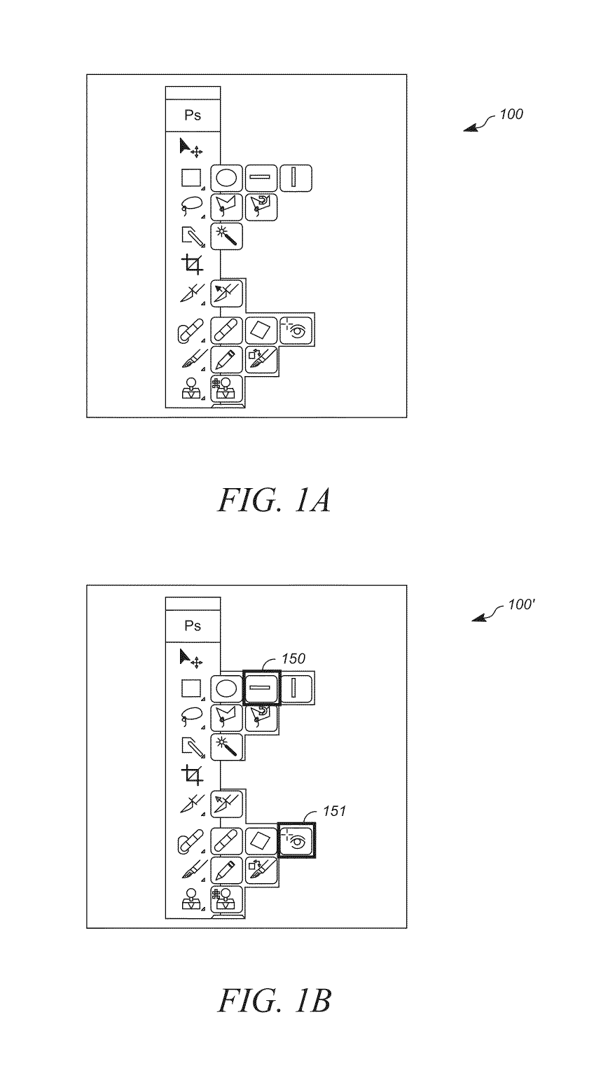

FIGS. 1A and 1B depict graphical user interfaces (GUIs) 100 and 100′ having various GUI components, in accordance with example embodiments of the present invention. A “GUI component,” as used herein refers to a graphical feature or graphical building block of a GUI. Such a GUI component can represent information and an action available to a user. Examples of GUI components include icons and menus. An icon is a small picture that can represent, for example, a command, a window, an object (e.g., a file or directory), a program, or a hypertext link. A menu is a listing of commands or options. Icons and menus are usually selectable. It should be noted that that a GUI component may also be referred to as a “component,” and therefore, terms “GUI component” and “component” may be used interchangeably.

As depicted in FIG. 1A, the GUI 100 includes various GUI components represented by icons, which can be selected by a user, that represent commands in an application. Embodiments of the present invention can track a user's usage of the GUI components when interacting with an application. Additionally, other users' usages of the same GUI components on other computing devices are also tracked. All the tracking information from multiple users is stored on a computing device. The application then analyzes the tracking information from a group of users and then highlights one or more GUI components based on their usages. For example, as depicted in FIG. 1B, the GUI 100′ includes the same GUI components as discussed above, but two particular GUI components 150 and 151 are highlighted with darker borders.

The application can highlight these GUI components 150 and 151 based on a variety of criteria. For example, the application selects the GUI components 150 and 151 to highlight because they are popularly used amongst all users. In another example, the application selects the GUI components 150 and 151 to highlight because they are popularly used amongst a group of users having the same occupation, such as web designers. Such highlighting can provide a variety of helpful information to a user. For example, a user using a photograph editing program may not have the expertise to select a certain filter effect with which to apply to a photograph to achieve a certain look. As a result, embodiments of the present invention can highlight various filter effects that are popularly used by, for example, portrait photographers, landscape photographers, or fashion photographers.

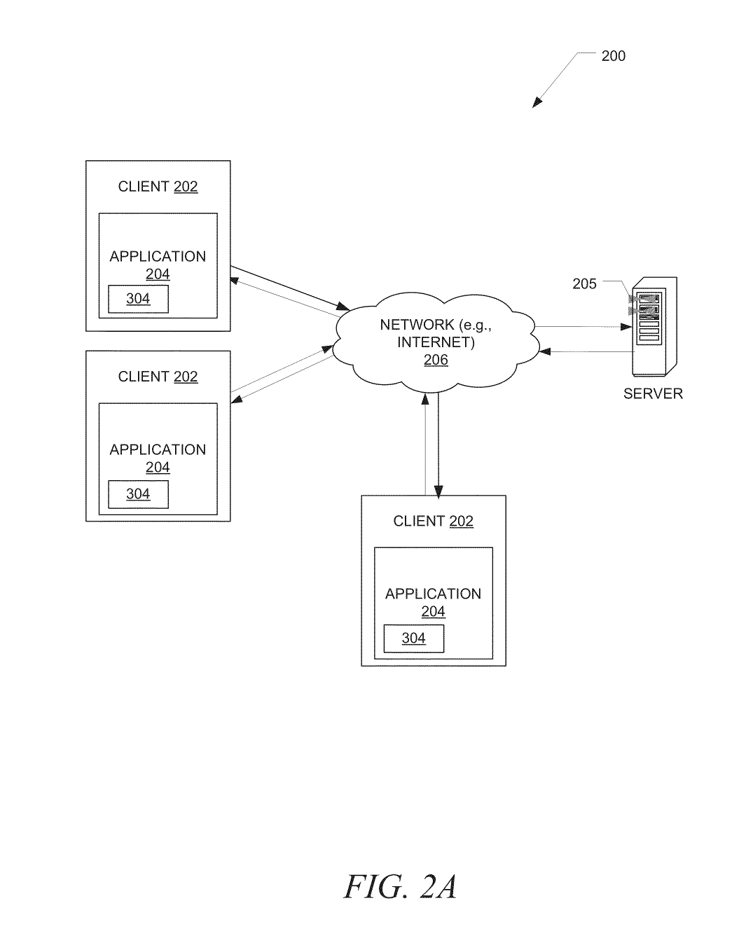

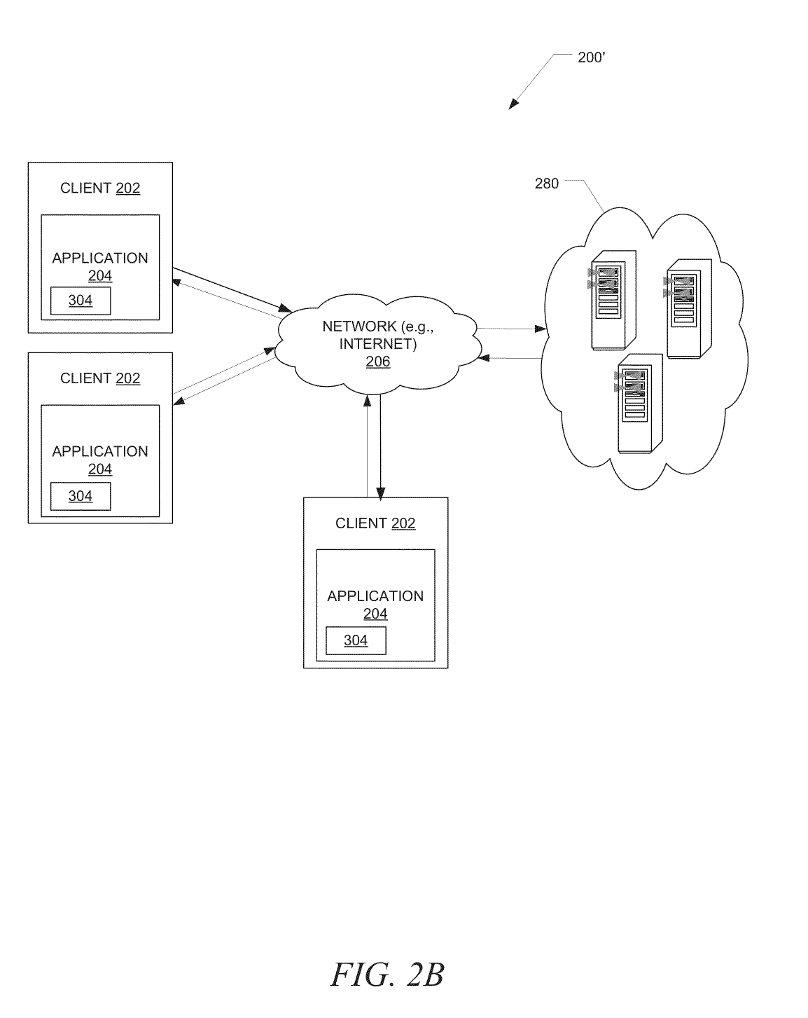

FIGS. 2A and 2B are diagrams of example embodiments of various network systems 200 and 200′, which can provide the highlighting functionalities described herein, such as the highlighting depicted in FIG. 1B. In FIG. 2A, the network system 200 includes various computing devices 202 and 204 in communication by way of network 206, which may include one or more local area networks (LANs) and/or wide area network (WANs), such as the Internet. In this example, the network system 200 includes client computing devices 202 (“client”) and server computing device 205 (“server”).

Clients 202 can include, for example, a computer system based on a processing unit and a memory, a portable computing device (e.g., tablet computer and laptop computer), a mobile phone (e.g., a smart phone), a personal digital assistant, and other computing devices that can display graphics. Each client 202 can execute a variety of different applications 204, such as word processing programs, graphics editing programs, web browsers, and other applications. As explained in more detail below, each application 204 can include a highlight tracking module 304 that tracks the usage of GUI components by a user and transmits such tracking information, along with other user information to, for example, the server 205 for storage.

Server 205 can provide server side functionalities (e.g., services and tasks), by way of network 206, to one or more clients 202. Particularly, the server 205 may host a variety of executable codes that, when executed, provide the functionalities described herein. In turn, clients 202 can directly or indirectly rely on the server 205 for information and application tasks. In one embodiment, the server 205 can be configured to provide social networking services, which can include online services, platforms, or sites that are directed to building and maintaining social relations among users, who, for example, share common interests and/or activities. Other examples of server 205 include an application server, a web server, and a database server. As explained in more detail below, the server 205, in one embodiment, can store the tracking information and other user information of all users of clients 202. Having access to such information, the server 205 can then identify which of the GUI components to highlight in each application 204 based on a variety of different criteria.

In an alternate embodiment, the server can be located in a cloud computing environment. In the embodiment depicted in FIG. 2B, the network system 200′ includes various computing devices 202 in communication by way of network 206. In this example, a cloud computing environment 280 provides the server side functionalities, by way of network 206, to one or more clients 202. Generally, cloud computing is a model for enabling on-demand network access to a shared pool of configurable computing resources (e.g., networks, servers, storage, applications, and services) that can be provisioned and released with minimal management effort or service provider interaction. The cloud computing environment 280 can include applications and enterprise services. The applications running on the cloud infrastructure are accessible from various client platforms (e.g., clients 202) through various client interfaces, such as applications 204. In the cloud computing environment 280, each application relies on one or more enterprise services, which refer to the underlying structure supporting communications among units of work (also referred to as services) executed on behalf of the applications. The services provided by the enterprise applications are pooled to serve multiple applications and client platforms with different physical and virtual resources dynamically assigned and reassigned according to user demand.

It should be appreciated that while the network systems 200 and 200′ shown in FIGS. 2A and 2B employ a client-server architecture, the present disclosure is not limited to such an architecture, and could equally well find application in a distributed or peer-to-peer architectural system. In such a per-to-peer architecture system, each peer client 202 (or peer client computing device) can be configured to store the tracking information along with other user information. As a result, each client 202 can communicate with each other peer to provide the functionalities that would be otherwise be provided by the server 205 or cloud computing environment 280.

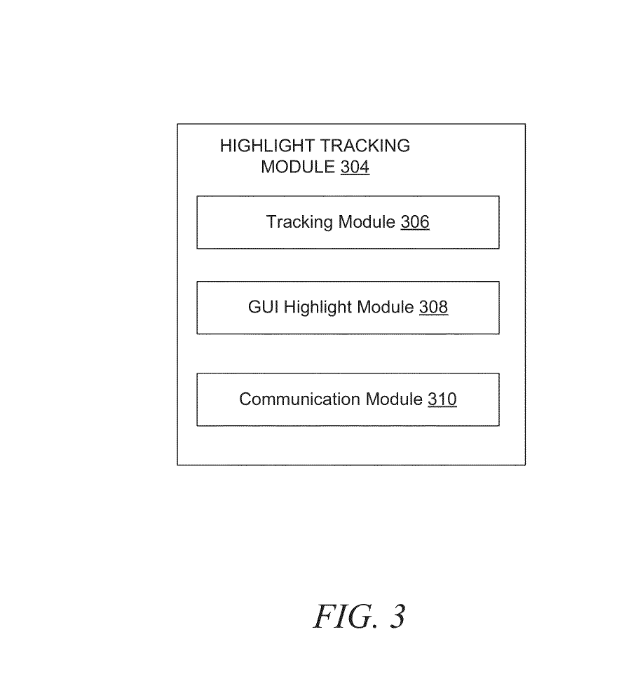

FIG. 3 depicts a block diagram of a highlight tracking module 304, in accordance with an example embodiment, that can be deployed in the network system 200 depicted in FIG. 2. For example, the highlight tracking module 304 may form a part of the client computing device 202 in the network system 200. Referring to FIG. 3, in various embodiments, the highlight tracking module 304 may be used to implement computer programs, logic, applications, methods, processes, or software to highlight GUI components based on their usages by different users, as described in more detail below.

In the example depicted in FIG. 3, the highlight tracking module 304 includes a tracking module 306, a GUI highlight module 308, and a communication module 310. The tracking module 306 essentially tracks a number of times that each GUI component is selected by a user when using a computing device. As explained in more detail below, the communication module 310 is configured to communicate this tracking information to another computing device on a network for storage.

The GUI highlight module 308 is configured to highlight one or more GUI components based on other users' usages of the GUI components. For example, in one embodiment, the communication module 310 can query a computing device on the network that stores tracking information for multiple users to identify which of the GUI components to highlight. The communication module 310 then communicates the identities of the GUI components to the GUI highlight module 308.

It should be appreciated that in other embodiments, the highlight tracking module 304 may include fewer or more modules apart from those shown in FIG. 3. For example, in an alternate embodiment, the tracking module 306 can be integrated with the GUI highlight module 308. The modules 304, 306, 308, and 310 may be in the form of software that is processed by a processor. In another example, as explained in more detail below, the modules 304, 306, 308 and 310 may be in the form of firmware that is processed by application-specific integrated circuits (ASIC), which may be integrated into a circuit board. Alternatively, the modules 304, 306,308 and 310 may be in the form of one or more logic blocks included in a programmable logic device (e.g., a field programmable gate array (FPGA)). The described modules 304, 306,308 and 310 may be adapted, and/or additional structures may be provided, to provide alternative or additional functionalities beyond those specifically discussed in reference to FIG. 3. Examples of such alternative or additional functionalities will be discussed in referenced to the flow diagrams discussed below.

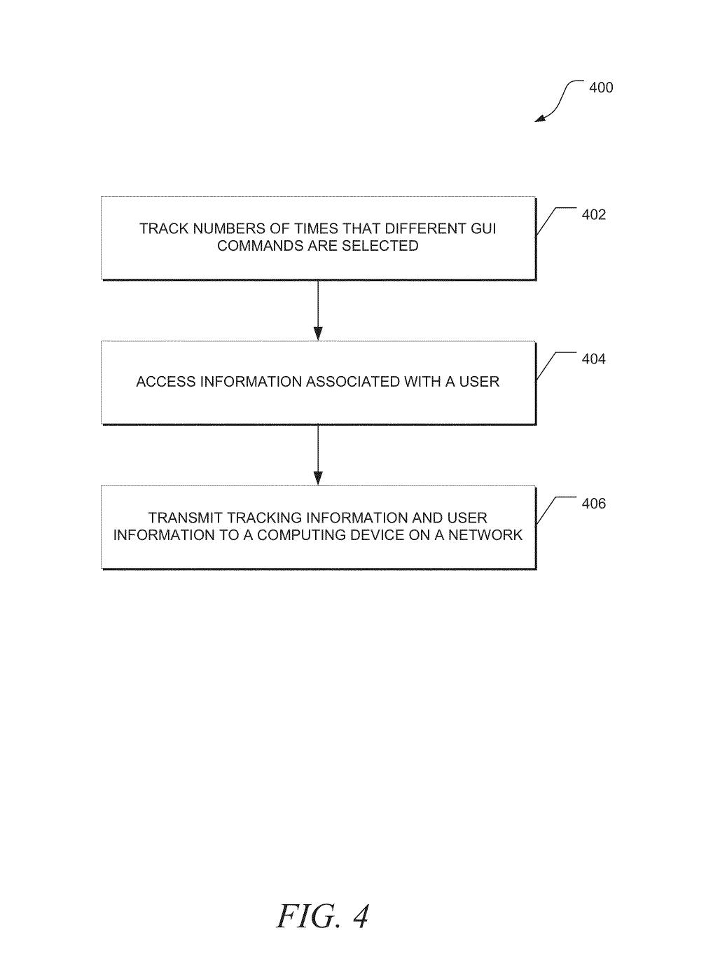

FIG. 4 depicts a flow diagram of a general overview of a method 400, in accordance with an embodiment of the present invention, for tracking usage of GUI components by a user. In an example embodiment, the method 400 may be implemented by the tracking module 306 and communication module 310 described in FIG. 3. Referring to FIG. 4, the tracking module, at 402, can track a number of times that each GUI component is selected by a user when using the application. In particular, the tracking module tracks this number over a period of time. For example, the tracking module can track a user selecting a particular GUI component that represents a paste command three times over a period of one hour. In another example, the tracking module can track a user selecting a particular GUI component that represents a copy command ten times over a period of fifteen minutes. As used herein, this tracked number can also be referred to as “tracking information.”

The tracking module, at 404, also accesses information associated with the user. Here, this “user information” can be a variety of data associated with the user. For example, user information can include an occupation of the user. An occupation refers to a user's principal work or business. Examples of occupations include entrepreneurs, homemakers, web designers, engineers, and other occupations. In another example, user information can be an identity of the user, such as a user's name and account name. Other examples of user information include a user's gender, age, ethnicity, education, location, and group affiliation.

At 406, the communication module then transmits the tracking information and user information to a computing device on a network. As previously described, this computing device can be a server or peer computing device or even a single computing device that is configured to store both tracking information and user information associated with multiple users.

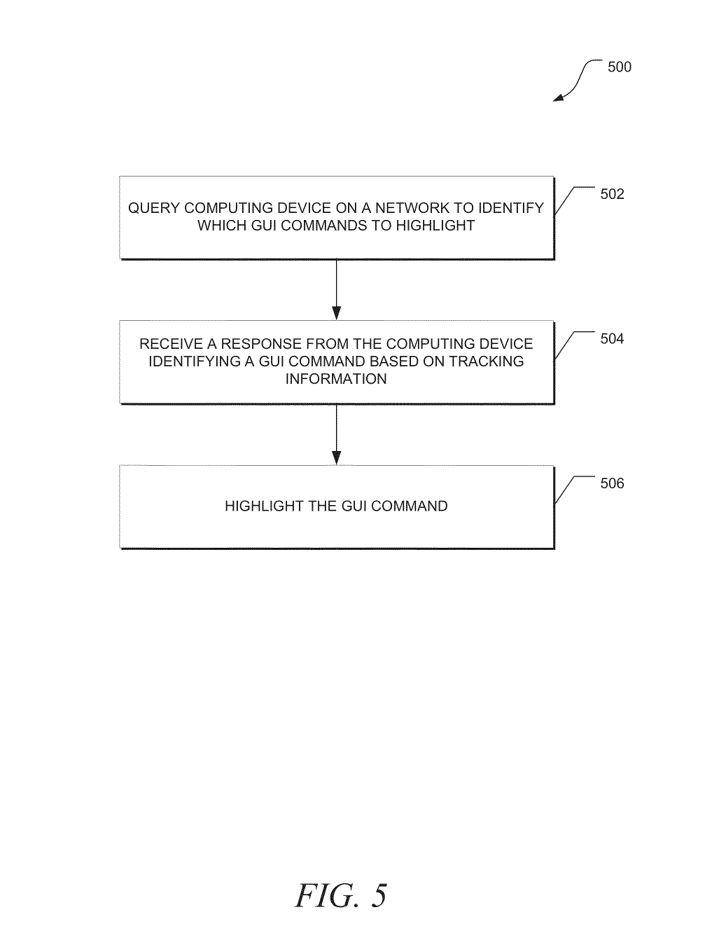

FIG. 5 depicts a flow diagram of a general overview of a method 500, in accordance with an example embodiment, for highlighting certain GUI components. In an example embodiment, the method 500 may be implemented by the GUI highlight module 308 and the communication module 310 described in FIG. 3. Referring to FIG. 5, the communication module, at 502, can query another computing device on a network to identify which of the GUI components to highlight. A “query,” as used herein, is an enquiry about information. For example, the query can be an enquiry about tracking information associated with one or more users. In another example, the query can be an enquiry about user information associated with one or more users. In yet another example, the query can be an enquiry to identify which of the GUI components to highlight. This query can specify a variety of different criteria with which to identify the GUI components. For instance, the query can be a request for a computing device to identify all GUI components that are popular based on the tracking information. In another example, the query can be a request for a computing device to identify which GUI components are popular amongst a group of users having the same occupation, such as a web developer or a database developer. In yet another example, the query can be a request for a computing device to identify which GUI components are popularly selected by a certain individual user. Additionally, as an example, the query can be a request for a computing device to identify which GUI components are popularly selected by users based on their physical location.

Upon transmittal of the query, the communication module then receives a response from the computing device, at 504, identifying one or more GUI components based on the tracking information that satisfies the query. That is, the communication module receives a response to the query identifying one or more GUI components to highlight. The identification is based on at least the tracking information associated with one or more users. In one embodiment, the response can include a set of component identifiers that identifies GUI components. In addition to the component identifiers, the response can also include tracking information associated with the component identifiers. As explained in detail below, in one embodiment, the tracking information can include an average number of times that each identified GUI component has been selected by multiple users.

With this information, the GUI highlight module, at 506, then highlights the GUI components identified in the response. As used herein, “highlighting” a GUI component is to emphasize the GUI component or to make the GUI component prominent. A GUI component may be highlighted, for example, by changing a color of the GUI component to a different color (including changing the hue or saturation), adding an indicator to the GUI component (e.g., a border, a star, and a background), pulsating the GUI component, assigning alphanumeric strings of a GUI component with a particular print style (e.g., bold, italic, and underlined).

Additionally, embodiments of the present invention can highlight in varying degrees or intensity based on the number of times a GUI component has been selected. That is, the GUI highlight module can assign a degree of highlighting based on a number of times that a certain GUI component has been selected. For example, the response received at 504 can include a set of component identifiers and a set of numbers assigned to the component identifiers. Each number identifies a number of times with which each GUI component has been selected. As explained in detail below, the number can be an average number of times that multiple users have selected a particular GUI component. As a result, the GUI highlight module can then assign a degree of highlight for each GUI component and as a result, a user can visually rank the GUI components relative to each other based on the highlights. For example, a GUI component with a high usage number can be assigned a brighter color when compared to another GUI component with a lower usage number. The highlighting can therefore be implemented in a gradation showing how each component is ranked relative to each other. Other examples of degrees of highlighting that can be applied to a GUI component include adding graphics of a number of stars or graphics of a thermometer, both of which can indicate varying degrees of highlight.

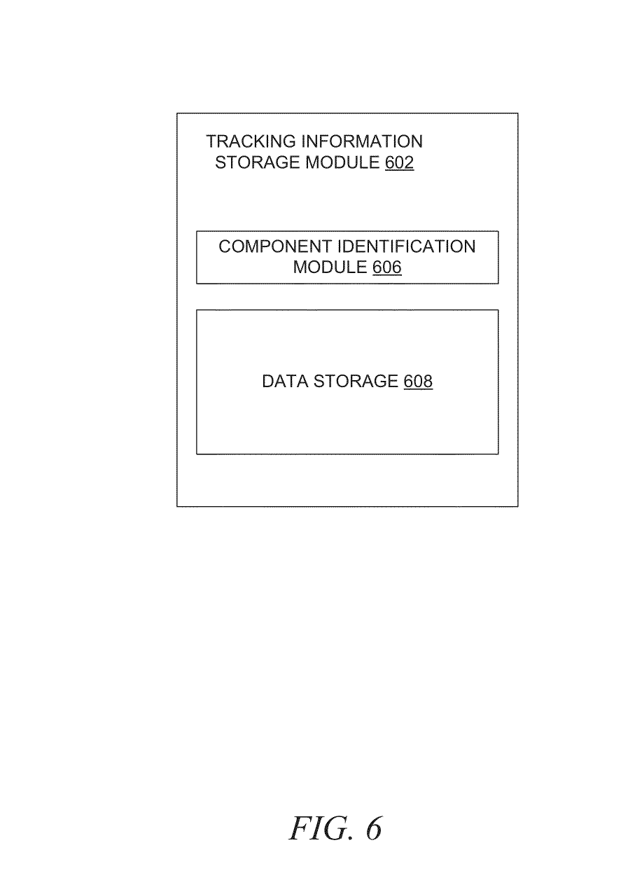

FIG. 6 depicts a block diagram of a tracking information storage module 602, in accordance with an example embodiment, that can be deployed in the network system 200 depicted in FIG. 2. For example, the tracking information storage module may form a part of the server 205 or a part of the client computing device 202 in the network system 200. Referring to FIG. 6, the tracking information storage module 602 may be used to implement computer programs, logic, applications, methods, processes or software to store tracking information along with other information, as described in more detail below.

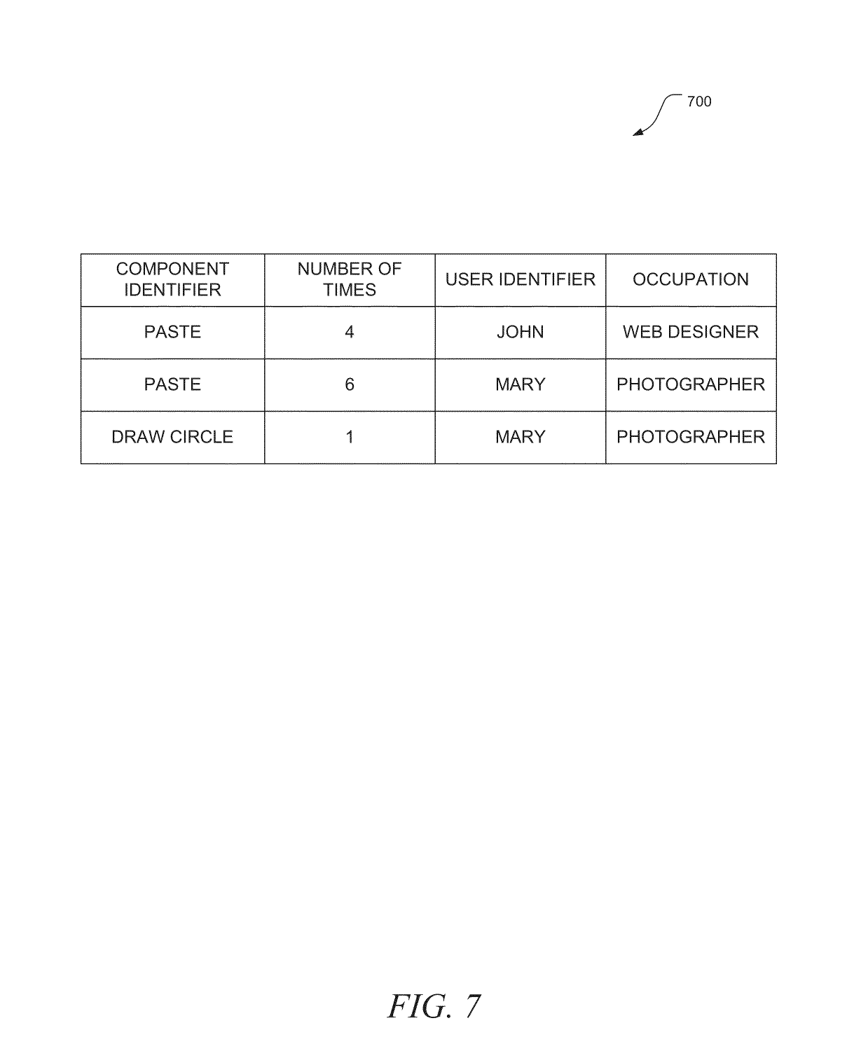

In the example depicted in FIG. 6, the tracking information storage module 602 can include a component identification module 606 and a data storage 608. The component identification module 606 can use the various information stored in the data storage 608 to identify one or more GUI components to highlight. The data storage 608 can include a variety of different data structures that are configured to store tracking information, user information, and other data relevant to highlighting GUI components. Examples of data structures include database tables, arrays, linked lists, and documents. A database table 700 depicted in FIG. 7 is an example of such a data structure that can be included in the data storage 608. In reference to FIG. 7, the database table 700 is a set of data elements that is organized using a model of vertical columns, which are identified by their names, and horizontal rows. The columns include “Component Identifier,” “Number of times,” “User Identifier,” and “Occupation.” The “Component Identifier,” as described above, identifies the GUI component that has been selected by a user. The “Number of Times” is a tracked number of times that a GUI component, as identified by the component identifier, has been selected by a user. The “User Identifier,” in this example, is a user's name. The “Occupation,” in this example, is a user's occupation, as described above. In this example, a combination of the Command Identifier and User Identifier can serve as unique keys into the database, but it should be noted that other database schemas can be used depending on the usage data most often requested.

Each row in the database table 700 represents a set of related data. For example, the “paste” GUI component has been selected four times by John who is a web designer. The same “paste” GUI component has been selected six times by Mary who is a photographer. Here, John and Mary are using the same application with the same set of GUI components, but on different computing devices.

Referring to FIG. 6, it should be appreciated that in other embodiments, the tracking information storage module 602 may include fewer or more modules apart from those shown in FIG. 6. For example, in an alternate embodiment, the component identification module 606 can be separated into two or more modules. The modules 602, 606, and 608 may be in the form of software that is processed by a processor. In another example, as explained in more detail below, the modules 602, 606, and 608 may be in the form of firmware that is processed by ASICs. Alternatively, the modules 602, 606, and 608 may be in the form of one or more logic blocks included in a programmable logic device (e.g., FPGA). The described modules 602, 606, and 608 may be adapted and/or additional structures may be provided, to provide alternative or additional functionalities beyond those specifically discussed in reference to FIG. 6. Examples of such alternative or additional functionalities will be discussed in reference to the flow diagram discussed below.

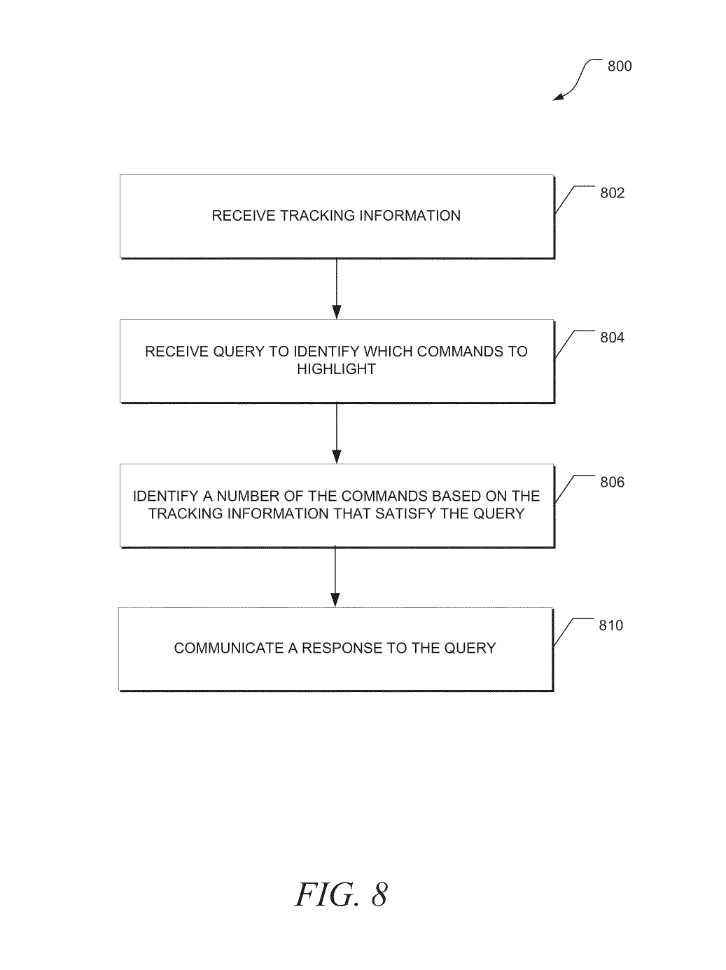

FIG. 8 depicts a flow diagram of a general overview of a method 800, in accordance with an embodiment, for identifying which GUI components to highlight based on the received tracking information. In an example embodiment, the method 800 may be implemented by the tracking information storage module 602 as depicted in FIG. 6. Referring to FIG. 8 at 802, the tracking information storage module receives, from multiple computing devices, tracking information that identifies the number of times that different GUI components have been selected by different users when using computing devices. The tracking information storage module then stores the received information in a data storage.

In addition, the tracking information storage module, at 804, receives a query from one of the computing devices to identify which of the different GUI components to highlight. The component identification module, at 806, then identifies a number of the GUI components based on the tracking information that satisfies the query. For example, in one embodiment, the component identification module can directly query one or more database tables that store the tracking information to identify various GUI components. For instance, the component identification module can query a database table to identify the top four GUI components that are popular amongst all users.

In an alternate embodiment, the component identification module can query a database table based on additional criteria, such as user information. For instance, the component identification module can query a database table to identify the ten most popular GUI components selected by users having a particular occupation. In another example, the component identification module can query a database table to identify the five most popular GUI components selected by users of a certain age group, such as teenagers.

In addition to identifying GUI components based on user information, the GUI components can also be identified based on identifying different users that are connected with each other on a social network. In this alternate embodiment, a server that provides social network servers, for example, can store all the tracking information and user information. Additionally, such a server is also configured to store information about how each user is connected to each other in a social network (e.g., a friends list). As a result, the component identification module can identify all the users who are included in a group in a social network and identify only the GUI components that are selected by the users within the group. In other words, the component identification module 606, in this example, can identify which GUI components to highlight based on the users' connections with each other. For example, in reference to FIG. 7, a social network server stores information about John's friends and from this information, the server can identify that Mary is not John's friend. As a result, when extracting information to identify which of the GUI components to highlight, the component identification module excludes Mary's tracking and user information. However, if the social network server identifies that John and Mary are friends, then the component identification module uses both John's and Mary's tracking and user information in the identification.

Still referring to FIG. 8, after the GUI components have been identified, the tracking information storage module, at 810, then communicates a response to the query with the response identifying the GUI components to highlight. For example, in one embodiment, the response can include the different component identifiers that have been identified to satisfy the query. In an alternate embodiment, the response can also include an average number with which each GUI component has been selected by multiple users. Particularly, the component identification module can extract from a data storage the number of times that each GUI component has been selected for multiple users. Using this extracted set of numbers, the component identification module calculates an average of the set of numbers for each GUI component. For example, in reference to FIG. 7, John has selected the GUI component “paste” four times while Mary has selected the same GUI component six times. The component identification module calculates an average of five from four and six. The response includes this five average assigned to “paste” command identifier. As described above, in one embodiment, a highlight tracking module can use this average to assign a degree of highlight to a GUI component.

In another embodiment, the response can include a weighted average based on a size of a social network. Particularly, the component identification module can extract from a data storage the number of times that each GUI component has been selected for multiple users associated with each other in a social network. Using this extracted set of numbers, the component identification module calculates a weighted average of the set of numbers for each GUI component. The weight can be applied based on a size of a user's social network. For example, more weight may be given to a user having a large social network when compared to another user having a small social network. Alternate embodiments can use other algorithms analyze the tracking and user information, such as a total count of all uses, a maximum number of uses by any given user, and a median number of uses.

In reference to FIG. 8, it should be noted that the tracking information received at 802, the response communicated at 810, and any messages discussed above to and from a computing device may be encoded in Extensible Markup Language (XML) or other encoding for use in the transport of data.

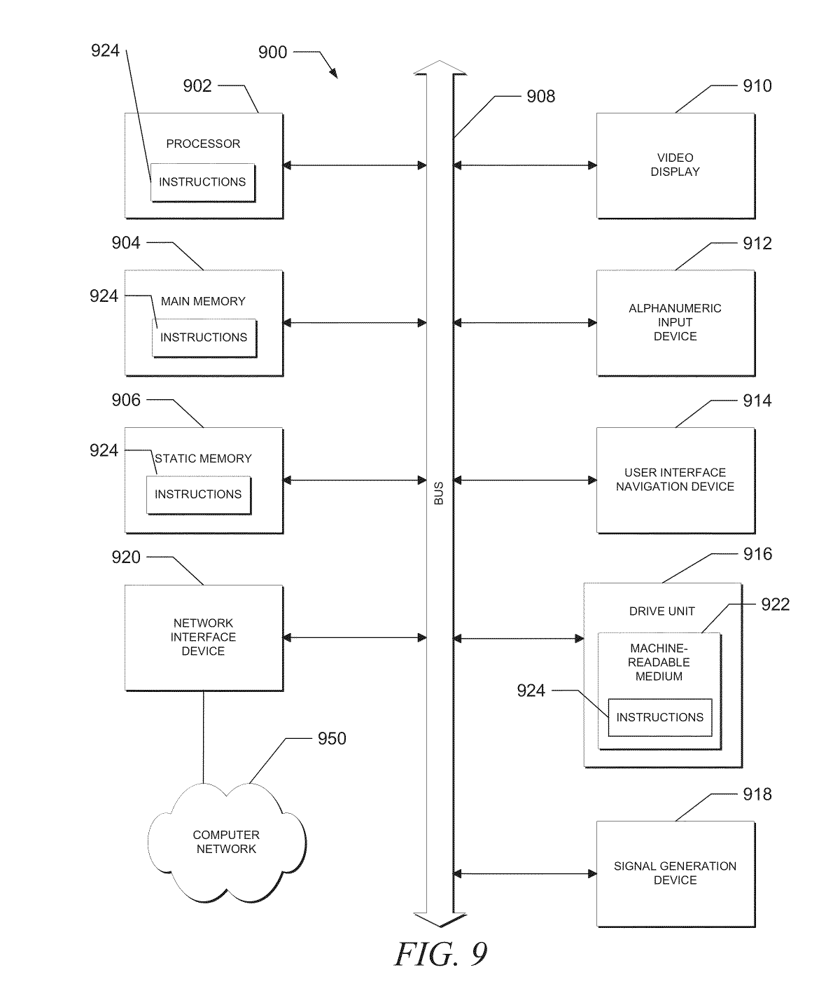

FIG. 9 depicts a block diagram of a machine in the example form of a computing device 900 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may also operate as a single un-network entity which is self-contained.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computing device 900 includes a processor 902 (e.g., a central processing unit (CPU), a graphics processing unit (GPU) or both), a main memory 904 (e.g., random access memory), and a static memory 906 (e.g., static random-access memory), which communicate with each other via bus 908. The computing device 900 may further include video display unit 910 (e.g., a plasma display, a liquid crystal display (LCD) or a cathode ray tube (CRT)). The computing device 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 (a type of non-volatile memory storage) includes a machine-readable medium 922 on which is stored one or more sets of data structures and instructions 924 (e.g., software) embodying or utilized by any one or more of the methodologies or functions described herein. The data structures and instructions 924 may also reside, completely or at least partially, within the main memory 904 and/or within the processor 902 during execution thereof by computing device 900, with the main memory 904 and processor 902 also constituting machine-readable, tangible media.

The data structures and instructions 924 may further be transmitted or received over a computer network 950 via network interface device 920 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the computing device 900) or one or more hardware modules of a computer system (e.g., a processor 902 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as FPGA or ASIC) to perform certain operations. A hardware module may also comprise programmable logic or circuitry (e.g., as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 902 configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine, but deployed across a number of machines. In some example embodiments, the processors 902 may be located in a single location (e.g., within a home environment, an office environment or as a server farm), while in other embodiments the processors 902 may be distributed across a number of locations.

While the embodiment(s) is (are) described with reference to various implementations and exploitations, it will be understood that these embodiments are illustrative and that the scope of the embodiment(s) is not limited to them. In general, techniques for highlighting GUI components may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method of highlighting different graphical user interface (GUI) components, the method comprising:
receiving, from multiple computing devices, tracking information identifying numbers of times that the different GUI components have been selected by different users when using the multiple computing devices;
receiving a query, from a computing device that provides the different GUI components, to identify which of the different GUI components to highlight;
identifying a GUI component from the different GUI components based on the tracking information that satisfies the query; and
communicating a response to the query, the response identifying the GUI component to highlight.

2. The method of claim 1, further comprising:
identifying a set of the numbers associated with the identified GUI component, each number in the set identifying a number of times that the identified GUI component has been selected by one of the different users; and
calculating an average of the set of the numbers,
wherein the response further includes the average.

3. The method of claim 1, wherein the identification of the GUI component comprises identifying a number of the different GUI components that are popular based on the tracking information.

4. The method of claim 1, further comprising identifying a group of the different users that are connected with each other in a social network, wherein the GUI component is identified based on a set of the tracking information associated with the group.

5. The method of claim 4, further comprising:
identifying a set of the numbers associated with the identified GUI component, each number in the set identifying a number of times that the identified GUI component has been selected by one of the different users; and
calculating a weighted average of the set of the numbers based on a size of the social network,
wherein the response further includes the weighted average.

6. The method of claim 1, wherein the tracking information further includes information associated with the different users.

7. The method of claim 1, wherein the information includes occupations of the different users.

8. The method of claim 1, wherein the information includes identities of the different users.

9. A non-transitory, machine-readable medium that stores instructions, which, when performed by a machine, cause the machine to perform operations comprising:
tracking numbers of times that different graphical user interface (GUI) components are selected by a user when using a computing device;
accessing information associated with the user;
transmitting the tracked numbers, component identifiers identifying the different GUI components, and the accessed information to a different computing device on a network, the different computing device storing tracking information associated with other users, the tracking information including different numbers of times that the different GUI components have been selected by the other users;
querying the different computing device to identify which of the different GUI components to highlight based on the tracking information associated with the other users;
receiving, from the different computing device, a response to the query identifying a GUI component from the different GUI components; and
highlighting the identified GUI component.

10. The method of claim 9, wherein the response additionally includes a number of times that the identified GUI component has been selected by the other users, and wherein the highlighting of the identified GUI component comprises:
assigning a degree of highlighting based on the number; and
highlighting the identified GUI component based on the degree.

11. The method of claim 9, wherein the different computing device is a server.

12. The method of claim 11, wherein the server is configured to host social network services.

13. The method of claim 9, wherein the different computing device is a peer computing device.

14. A system comprising:
an application having instructions that when executed by at least one processor, cause operations to be performed, the operations comprise providing graphical user interface (GUI) components for display by the computing device, and
a highlight tracking module having instructions that when executed by the at least one processor, cause operations to be performed, the operations comprise:
querying a different computing device on a network to identify which of the GUI components to highlight based on tracking information associated with other users;
receiving, from the different computing device, a response to the query identifying a GUI component; and
highlighting the identified GUI component.

15. The system of claim 14, wherein the operations of the highlight tracking module further comprises:
tracking a number of times that each GUI component is selected by a user when using the computing device;
accessing information associated with the user; and
transmitting the tracked numbers, component identifiers identifying the GUI components, and the accessed information to the different computing device, the different computing device storing tracking information associated with other users, the tracking information including different numbers of times that the GUI components have been selected by the other users.

16. The system of claim 15, wherein the information includes an occupation of the user.

17. The system of claim 15, wherein the information includes an identity of the user.

18. The system of claim 14, wherein the response additionally includes a number of times that the GUI component has been selected by the other users, and wherein the operation of highlighting the GUI component comprises:
assigning a degree of highlighting based on the number; and
highlighting the identified GUI component based on the degree.

19. The system of claim 14, wherein the operation of highlighting the GUI component comprises changing a color assigned to the GUI component to a different color.

20. A system comprising:
a tracking information storage module when executed by at least one processor, cause operations to be performed, the operations comprising:
receiving, from multiple computing devices, tracking information identifying numbers of times that different GUI components have been selected by different users when using the multiple computing devices;
receiving a query, from a computing device that provides the different GUI components, to identify which of the different GUI components to highlight;
identifying a GUI component from the different GUI components based on the tracking information that satisfy the query; and
communicating a response to the query, the response identifying the GUI component to highlight.

21. The system of claim 20, wherein the system is located in a cloud computing environment.
